(19) United States
(12) Patent Application Publication
(10) Pub. No.: US 2016/0003289 A1
(43) Pub. Date: Jan. 7, 2016

(54) Filament Wound Composite Tie Rod

(71) Applicant: Advent Aerospace, Inc., Rye, NH (US)

(72) Inventor: Michael Wayne Brace, St. Petersburg, FL (US)

(21) Appl. No.: 14/322,174

(22) Filed: Jul. 2, 2014

(51) Int. Cl. F16C 3/02; B29C 65/00; F16C 7/02

(52) U.S. Cl. CPC F16C 3/026; F16C 7/026; B29C 66/721

(57) ABSTRACT

A filament wound composite tie rod and method for fabricating the same includes end fittings coupled to a structural member tube and held by a filament-wound structure. The end fittings include lugs to guide and hold the filament at proper angles while holding the filament in place on the end fittings. The filament wound composite tie rod provides both higher tension and/or higher compressive load carrying capability than existing tie rods at a significantly reduced weight.

### FIELD

This invention relates to the field of mechanical support devices and more particularly to a tie rod having good tension and compression strength compared to the mass of the tie rod.

### BACKGROUND

A tie rod is a slender structure used as a tie between two points. In many applications a tie rod is used primarily in tension. When there are compressive forces between the linkages or a moving mechanical linkage assembly, where at least one point of the mechanical linkage rotates relative to the other point in the linkage, a tie rod assembly is used in lieu of a cable or lanyard. When used in such a linkage the tie rod typically has bearing members affixed to both ends, at the points of the mechanical linkage. These bearing members often referred to as a rod ends, or rod end bearings.

In most applications involving the use of a tie rod the tensile load through the tie rod is the dominate load and as such the design and construction of the tie rod is typically optimized for the tensile loads expected. However when the subject tie rod is required to transmit higher compressive loads most of the physical features of the tie rods (such as the diameter of the tie rod or the material composition of the body of the tie rod) must grow in scale or increase in strength to be capable of carrying the subject compressive loads. In many applications where the overall weight if the tie rod assembly is a contributing factor to its design (such as aerospace and/or commercial aviation) the required size and composition of the requisite tie rod body often results in undesired weight (mass), cost, and/or envelope parameters. In aerospace applications in particular excess weight (mass) and envelope parameters have an extreme adverse effect to not only the mechanisms being tied together [through the tie rod assembly] but to many of the overall components associated with said mechanisms.

Typical tie rods used in aircraft and spacecraft assemblies often comprise a hollow cylinder (tube) formed from metal (such as aluminum or steel) or formed from a composite material (such as carbon fiber epoxy) with attachment fittings attached at both ends. The attachment fittings (often referred to as end fittings) are typically formed from metal primarily because of the mechanical properties of the hollow cylinder (tube) to which they attach or the rod ends which are attached to them.

The tie rods described above, when used in aerospace applications, are effective, durable and relatively light weight and can carry higher compressive loads than a slender, single piece tie rod but typically are rated for a low tensile load due to weaker mechanical attachments between the tube ends and the end fittings. This union between the tube and the end fittings is only as strong as the fasteners used.

Since it is common for several hundred tie rods to be used in a typical commercial or military aircraft the cumulative weight of the tie rods represents a significant overall percentage weight of the aircraft. To reduce weight, some tie rods are made from tubes fabricated from a composite material held in a resin [solid] matrix, such as fiberglass/epoxy and/or carbon-graphite/epoxy. One common methodology for the fabrication of composite tubes is that of filament winding.

Filament winding consists of the placement of composite filament bundles encapsulated in an uncured resin (solid) matrix in an open lattice structural shell at pre-determined angles (relative to the longitudinal axis) forming interlacing helical filaments that form a truss-like grid. Typically these bundles of filaments are held in solid resin matrixes which, after curing, form a strong, lightweight, stiff structural member. These fiber bundles are placed at an angle along the longitudinal axis required to maximize tension and/or torsion, but not both. Off-axis, low-angle)(+/−45° helically placed filaments carry both torsion and transverse shear forces and have good hoop strength. Off-axis, high-angle)(+/−20° helically placed filaments carry the highest tension loads but less compressive loads and very little hoop strength. High-angle filaments are typically not designed to carrying compressive loads anywhere near their rated tension loads.

A problem exists in utilizing the lightweight open lattice composite body described above for tie rod and/or strut applications because of the difficulty of attaching the end fittings of the tie rod/strut to the individual filaments at the end of the body, either before or after curing. If the composite bundles in the filament wound tube are cut at either (or both ends), for example as disclosed in US Pat. Pub No. 2010/0055383 to Schalla, et al, the tension carrying capabilities are seriously degraded as the tension loads are no longer evenly distributed along the single filament that was used to construct the tube. This aforementioned patent publication discloses a mechanical means by which to securely clamp to the [now truncated] ends of the filament bundles in an attempt to permanently secure the ends of these now individual filament bundles. While this end-fitting attachment methodology is an improvement over the typical tie rod assembly methodology (where a cut tube is affixed to an end fitting [at each end] with the use of adhesive and/or fasteners) it is by no means as strong in tension as other filament wound tie rod constructions where the individual filament bundles are properly placed [through standard filament winding processes] and then are allowed to be cured in place as such, leaving the tube lattice as a single, continuous filament.

US Pat. Pub. No. 2010/0122606 to Volker discloses a tie rod and force transmitting [filament wound] assembly for a tie rod whereas the ends of said tie rod assembly may allow for the placement and cure of a single filament bundle circumferentially around an end feature of the fitting (thus allowing for an improved tension load carrying capability) but does not provide a means to maintain fiber orientation or placement during the filament winding process. This is often problematic early during the filament winding process as the fiber bundles tend to form a cone of excess filament material at the end of the fitting as they are wrapped around the end feature. Since the wound filaments are typically coated in a very slippery, uncured resin (and applied under tension) they flatten out very quickly as they transition from the radial axis of orientation across a hard edge (lip) on to the longitudinal axis of orientation. This transition lip causes the filaments (under tension) to slip off-angle and fall out of place with greater ease as each layer of filament is deposited. Accordingly, an end fitting with no means to mechanically secure the filaments at the proper angle during the winding operation is very limited in the number of layers that can be deposited unless the angle of deposition of the filaments is very high (greater than 45°). This high angle of deposition causes a rapid loss in tension load carrying capability. In order to compensate for the degraded material properties of the filament bundles, more filaments bundles must be wound along the tie rod body. The extra filaments increase the weight and diameter of this tie rod design.

What is needed is a composite tie rod and method for producing such having a lightweight, open lattice, [single] continuous filament wound body that includes end fittings that allow the composite tie rod to be optimized for either tension or compressive loads and that allow either conventional or unique rod ends to be connected to the composite tie rod. The tie rod having higher load carrying capabilities in both tension and compression than prior tie rods without an increase in overall dimensions and mass to accommodate such higher load carrying capabilities.

### SUMMARY

A filament wound composite tie rod, fabrication and assembly method for the same using filament wound composite material fabrication technology including the addition of innovative subassemblies resulting in an improved composite tie rod that is optimized for load transfer in both tension and compression without altering the overall dimensions of the tie rod for an increase in either tension or compression load carrying capabilities.

Tie rod end fittings on ends of the filament wound composite tie rod allow for fewer layers of filament wound composite material on a given diameter tube while allowing for an improved method of filament winding that provides greater fiber angle placement control. The tie rod end fittings provide greater tensile load carrying capability compared with similar tie rod construction at a reduced weight.

The end fittings of the composite tie rod are uniquely designed and optimized for the filament wound composite material fabrication methodology and do not require the truncation of the single (or multiple), continuous composite filament(s) that comprises the exterior structure of the tie rod thus allowing for the maximum tensile load transference of the filament wound material from one end fitting of the tie rod to the other end fitting on the tie rod. The end fittings also accommodate optimum filament winding angle placement during a mufti-layer filament lamination process.

The end fittings of the tie rod are uniquely designed to offer maximum compressive load transfer from one end of the tie rod to the other end of the tie rod through a pre-cured structure secured to the interior of the end fittings in the tie rod.

In some embodiments, the tie rod is manufactured completely from materials, fabrics, resins and adhesives common to composite material technology and does not depend on an adhesive bond for any mechanical properties.

In one embodiment, a filament wound composite tie rod is disclosed including a structural member tube and a pair of end fittings. Each end fitting has a cylindrical end feature and a cylindrical body. The cylindrical body has a plurality of lugs. A first of the end fittings is attached to a first end of the structural member tube and a second of the end fittings is attached to a second, distal end of the structural member tube. The filament wound composite tie rod includes a filament wound repeatedly around the end fittings and along the structural member tube. The filament is wound at an angle between 0 degrees and 90 degrees with respect to a longitudinal axis of the structural member tube and the filament is wound around the cylindrical end feature of the end fittings at an arc of greater than 180 degrees.

In another embodiment, a method of fabrication a filament wound composite tie rod is disclosed including providing a composite tie rod base, having a structural member tube and a pair of end fittings. Each end fitting has a cylindrical end feature and a cylindrical body. The cylindrical body has a plurality of lugs. A first of the end fittings is attached to a first end of the structural member tube and a second of the end fittings is attached to a second, distal end of the structural member tube. The method includes winding a filament a number of turns around the end fittings and longitudinally around the structural member tube. Each winding of the filament is wound at an angle between 0 degrees and 90 degrees with respect to a longitudinal axis of the structural member tube and each winding passes around the cylindrical end feature of the end fittings at an arc of greater than 180 degrees.

In another embodiment, a filament wound composite tie rod is disclosed including a structural member tube and a pair of end fittings. Each of the end fittings has a cylindrical end feature and a cylindrical body. The cylindrical body has several lugs. A first of the end fittings is attached to a first end of the structural member tube and a second of the end fittings is attached to a second, distal end of the structural member tube. At least one filament is wound repeatedly around the end fittings and along the structural member tube. The filaments are wound at an angle between 0 degrees and 90 degrees with respect to a longitudinal axis of the structural member tube and each of the filaments is wound around the cylindrical end feature of the end fittings at an arc of greater than 180 degrees.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates components of a solid tie rod of the prior art.

FIG. 2 illustrates a solid tie rod of the prior art.

FIG. 3 illustrates components of a tie rod end fitting and tube of the prior art.

FIG. 4 illustrates an assembled tie rod end fitting and tube of the prior art.

FIG. 5 illustrates an exploded view of an exemplary filament wound composite tie rod.

FIG. 6 illustrates a plan view of an end of the exemplary filament wound composite tie rod, partially wound with a filament.

FIG. 7 illustrates a perspective view of the end of the exemplary filament wound composite tie rod, partially wound with a filament.

FIG. 8 illustrates a plan view of the end cap of the filament wound composite tie rod, ready to install on the tube.

FIG. 9 illustrates a cut plan view of the end cap of the filament wound composite tie rod, installed on the tube.

FIG. 10 illustrates a cross sectional view of the end cap of the filament wound composite tie rod, installed on the tube but before winding of the filament.

FIG. 11 illustrates a cross sectional view of the end cap of the filament wound composite tie rod, installed on the tube and attached to an end fitting.

FIG. 12 illustrates a cross sectional view of the end cap of the filament wound composite tie rod, installed on the tube after winding of the filament.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

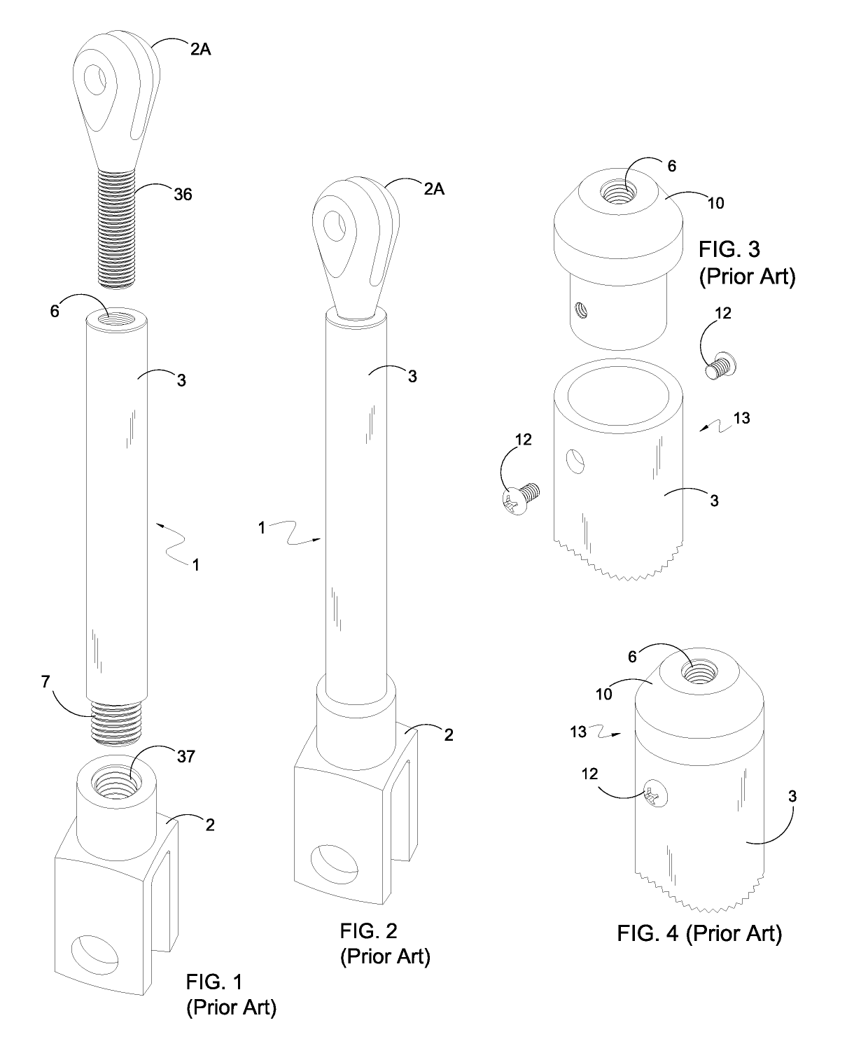

FIGS. 1 and 2 illustrate a first tie rod assembly 1 of the prior art. The tie rod assembly 1 of the prior art includes a structure member (tube) 3 and two rod end fittings 2/2A connected to the structure member (tube) 3 by threaded features 36/6/37/7, one at each end of the structure member (tube) 3, as is common to the aerospace industry. It is typical for the threaded features 36/6/37/7 at the ends of structure member 3 to be either internal [female] as is the internal threaded features 6 or to be external [male] as is the external threaded features 7. The type of threaded feature 6/7 is selected to match the end fittings 2/2A. For illustration purposes, the threaded features 6/7 are shown with both the internal thread feature(s) 6 and the external thread features(s) 7 though any arrangement of threaded features 6/7 is anticipated and known in the prior art. The structure member 3 is shown as a cylinder with a round cross section along the axis, but any design and fabrication of cross-sectional shape such as square, rectangular and/or I-Beam are known.

The mechanical property requirements of the structure member 3 dictate the design parameters of the structure member 3. To which as the compressive load requirements exerted in the axial, longitudinal direction, on the structure member 3 through the rod end(s) 2/2A increases in value, a comparative increase in the physical design parameters of the structure member 3 is required. This increase in physical design parameters is usually manifested in an increase in the physical size of the structure member 3 relative to the rod end(s) 2. In order to increase the compressive load capability in the axial direction of the structure member 3, the outer dimensions of the structure member 3 is increased in the radial direction. For the purpose of this disclosure this results in an increase in diameter of the structure member 3.

In aerospace applications, any such increase in required diameter (because of an increase in axial compressive load capability) results in an undesirable increase in weight (mass), to which, as the diameter of the structure member 3 increases, there comes a point where the structure member 3 need be duplicated out of separate end fitting(s) 10 and the structural member tubes 3 joined to the end fittings 10 by one or more mechanical fastener(s) 12 as in FIGS. 3 and 4. This methodology results in a tie rod assembly 13 that carries greater compressive axial loads than threaded mechanical interfaces 6/36/7/37 without a corresponding increase in weight (mass). This method of fabrication for tie rod assembly 13 is the more common for tie rod technology in the aerospace industry when additional axial compressive load carrying capability is required and weight (mass) is an issue.

The tie rod assembly 13 with end caps 10 typically carries greater compressive axial load(s) that the tie rod assembly 1 with threads 6/7 and has less mass than threaded mechanical interfaces 6/36/7/37.

Maximum [axial] tension loads applied to the tie rod assembly 1 though the rod end(s) 2 are limited to either the lesser of the tension load capability through [threaded] the mechanical interface of the rod end 2 and the structure member 3 or the tensile modulus properties of the structure member 3. Since tie rods are primarily used to carry [axial] tension, in this aforementioned tie rod technology, the lesser of these two values is often found in the [threaded] mechanical interface 6/36/7/37 between the structure member 3 and the rod end 2.

Maximum [axial] tension loads applied to the second tie rod assembly 13 through end fitting 10 are limited to either the tension load capability of the threaded mechanical interface 6/36/7/37 of rod end 2 secured in end fitting 10 or from the shear modulus [strength] of fastener(s) 12 used to mechanically secure the tube 3 to the end fitting 10. In this aforementioned tie rod technology the lesser of these two values is often derived from the shear modulus of fastener(s) 12 used to mechanically secure tube 3 to end fitting 10.

In summary, the first tie rod assembly 1 with the threaded mechanical interface 6/36/7/37 offers a better design for transmitting axial tension loads and the second tie rod assembly 13 with the fasteners 12 offers a better design for transmitting axial compressive loads when weight (mass) of the overall design is a critical feature.

To which, in common current tie rod fabrication technologies, an increase in [axial] tension load capabilities is often achieved with the first tie rod assembly 1 without a corresponding increase in weight. To increase [axial] compressive load capabilities, the second tie rod assembly 13 is the preferred construction methodology. However, a significant reduction in [axial] tension load capability is realized in tie rod assembly 13 construction methodology, and since tie rods are primarily used to carry tension loads this reduction often results in a highly undesirable lower strength-to-weight ratio of the first tie rod assembly 1.

The filament wound composite tie rod component fabrication and assembly method has the weight-saving advantages and [axial] compressive load characteristics of tie rod assembly 13 construction but also has the [axial] tensile load capabilities of tie rod assembly 1 (using structure member 3) and that said increases in axial compressive and axial tensile load capabilities are independent of each other and providing an increase in either axial tension and/or axial compression loads without an increase the diameter of the tie rod and without an increase the overall weight of the tie rod.

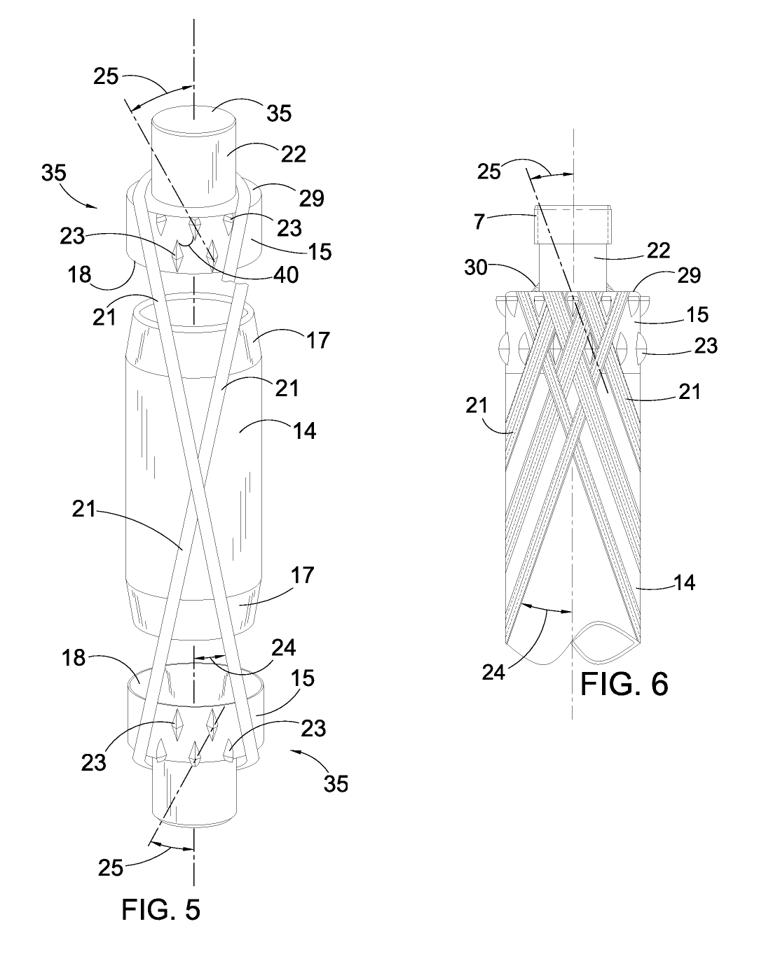

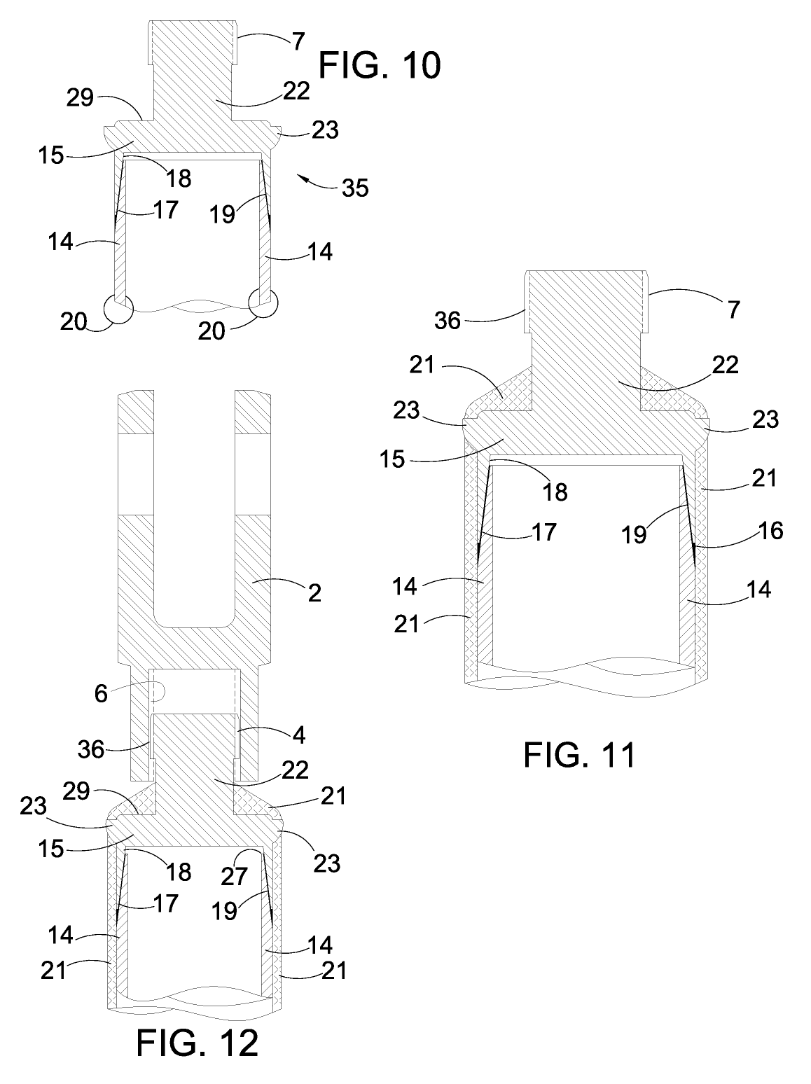

Referring to FIGS. 5-12, a structural member tube 14 (herein referred to as tube 14) is mated to end fitting(s) 15 at the union of tube taper feature(s) 17 and end fitting inner surface taper feature 18 as shown in FIGS. 9 and 10. An adhesive 19 is placed between the tube taper feature(s) 17 and the end fitting inner surface taper feature 18 and allowed to cure. This construction technology allows for 100% transmission of [axial] compressive loads transmitted by the end fitting(s) 15 to the tube 14 through the tube taper feature(s) 17 and the end fitting inner surface taper feature 18 without any further mechanical assistance. Therefore, the structural capability when placed in [axial] compressive load is limited only by the mechanical properties of the tube 14.

The angle of the taper on the tube taper feature(s) 17 and the angle of the taper on the end fitting inner surface taper feature 18 are preferably the same. During design, the angle of the taper is selected based upon the wall thickness 20 of the tube 14 so as to optimize the [axial] compressive loads placed upon the tube 14 and the angles shown in FIGS. 5, 8, 9, 10, 11 and 12 are examples of one such angle.

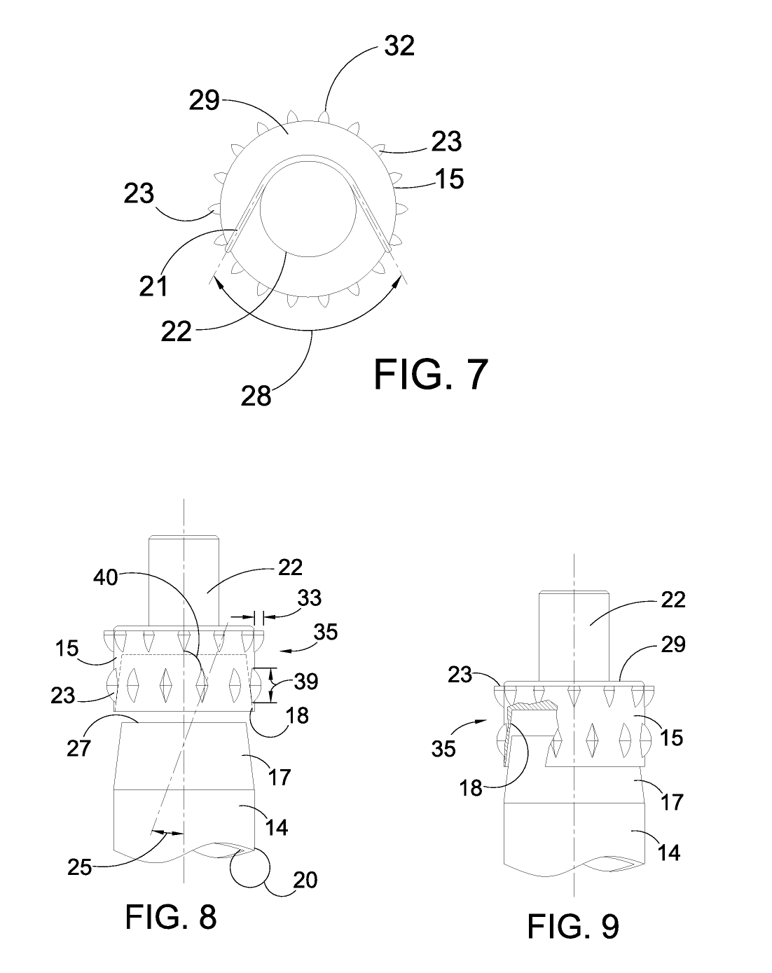

The tube 14 is mechanically affixed to the end fitting(s) 15 and serves as a mandrel [tool] for the placement of a continuous filament 21 wrapped over the end fitting(s) 15 using filament winding technology commonly used for the placement of composite material filaments (such as carbon [graphite], fiberglass, para-aramid fibers, poly paraphenylene terephthalamide fibers, etc.) pre-saturated (or not) with a compatible resin (such as two-part epoxy resin, thermoplastic resin, etc.). As the filament 21 is wound around the tube 14 and around the cylindrical end feature 22 of the end fitting(s) 15, the filament 21 is wrapped at an arc angle 28 (see FIG. 7) of more than 180° around cylindrical end feature 22 and deposited between raised features (lugs) 23 (herein referred to as lugs 23) located circumferentially around exterior of the cylindrical body 35 of the end fittings 15.

Filament winding technology places the filament 21 at a winding angle 24 relative to the longitudinal axis of the tube 14 as shown in FIG. 6. The winding angle 24 is derived (designed) to optimize the [axial] tension load carrying capability of the filament 21 along the longitudinal axis of the tube 14. The offset angle 25 (offset between the lugs 23 and the longitudinal axis of the tube 14) and the winding angle 24 relative to the longitudinal axis of the tube 14 are the same or very close to the same angle. This relationship creates a furrow 40 which captures the filament 21 as it is placed over the end fitting(s) 15 during the filament winding process and maintains the winding angle 24 after the proper amount of filament 21 is deposited at the termination of the filament winding process.

During the filament winding process, as the filament 21 is wound around the end fittings 15, a material build-up 30 of filament 21 forms radially around cylindrical end feature 22 on a top surface 29 of the end fittings 15. This material build-up 30 has effect on the wrap angle 28 to the point where filament 21 can no longer maintain wrap angle 28 of greater than 180° around cylindrical end feature 22.

Without a proper wrap angle 28 (e.g., greater than 180°), it is possible for the filament 21 to slip off of the top surface 29 of the end fittings 15 during axial tension loads. If one or more filaments 21 slip off of the top surface 29 of the end fittings 15 then the [axial] tension load capability is compromised. As this material build-up 30 of filament 21 occurs, the lug(s) 23 present a physical barrier to filament 21 to eliminate slip of filament 21 off the top 29 of end fitting(s) 15 and such maintains the desired [wrap] angle 28 relative to cylindrical end feature 22 and wind angle 24 of filament 21 relative to [longitudinal] axis of the tube 14. To which the lugs(s) 23 also serve to maintain [wrap] angle 28 of filament 21 as tension in filament 21 is applied during the filament winding process.

The lugs 23 preferably have a sharp or pointed tip feature 32, and have a height 33 from a circumference of the end fitting 15, an axial length 39, and a base width designed to accommodate the filament material winding process and the material characteristics of which the filament 21 is comprised and the amount of filament 21 used for the desired load characteristics. The height, the axial length 39 and the base width of the lugs 23 is selected during design depending on the wind angle 24 of the filament 21, the amount of the filament 21, and the physical characteristics of the filament 21. The physical representations of lugs 23 as shown is not limiting and any shape of lugs 23 are anticipated and fall within the scope of this disclosure.

The use of a single, continuous filament 21 is one basis filament wound composite tie rod for transmitting tension loads through the end fittings 15. It is anticipated that, additionally, different mechanical properties are achieved by wrapping more than one, continuous filament 21 around end fitting 15 and that the scope of this disclosure is not limited to the number of continuous filament(s) 21 used or to the type of filament 21 used in the fabrication of this invention. Each filament 21 used in the fabrication of the filament wound composite tie rod is continuous when wound around each end fitting 15. Also, there is no restriction on the composition of the filament 21 or filaments 21, and it is also anticipated that, in some embodiments, several filaments 21 are incorporated, each being made of different filament materials.

Accordingly, the design of the size, number and area density of the lugs 23 around the circumference 38 of the end fitting 15 are selected dependent on the desired axial tension load capability and are not constrained by the figures of this disclosure. Furthermore, no adhesive bond or additional mechanical connection between the tube 14 and end fittings 15 is necessary for the successful application of axial tension loads to this disclosure.

The tie rods, in general, require a mechanical feature of the cylindrical end feature 22 of the fittings 15 for mechanically inking two separate structures (not shown). FIG. 1 and FIG. 2 show examples of mechanical feature being rod ends 2/2A which have either a male threaded feature 36 or a female threaded feature 37 to which structure member 3 is mechanically affixed. Although there are many ways anticipated to affix the filament wound composite tie rod to structures, one example is shown in FIG. 11. In this, cylindrical end feature 22 is has an external threaded feature 36 and rod end fittings 2 has a corresponding internal threaded feature 6. There are many variations and combinations for mechanically fastening a mechanical feature (not pictured) to the cylindrical end feature 22 on the end fittings 15 and all of such are included here within.

In some embodiments, the filament(s) 21 are anticipated to be wound using conventional filament winding methodology in an uncured state (such as composite materials consisting of a fabric and resin matrix) and then allowed to cure in order to achieve tie rod's designed capability. Accordingly, filament 21 is also anticipated to be wound using conventional filament winding methodology in a cured state (such as metal wire or thermoplastic composite material) to achieve the filament wound composite tie rod's capability. When said filament 21 is wound in a cured or uncured state, it is anticipated that in some embodiments, additional processes and procedures be performed to the filament(s) 21 to enhance the invention's load-carrying capability and/or usefulness. The filament 21 or the applied state of the filament 21 does not limit the scope of this disclosure nor does any secondary process or procedure performed on or against the filament 21, either before or after the filament 21 is wound. Any composition, size, shape, color of the filament 21 is anticipated.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A filament wound composite tie rod comprising:
a structural member tube;
a pair of end fittings, each end fitting having a cylindrical end feature and a cylindrical body, the cylindrical body having a plurality of lugs, a first of the end fittings attached to a first end of the structural member tube and a second of the end fittings attached to a second, distal end of the structural member tube;
an open lattice body formed of interlacing filaments held in a solid matrix wound repeatedly around the end fittings and the structural member tube, along the structural member tube, the filaments being wound at an angle between 0 degrees and 90 degrees with respect to a longitudinal axis of the structural member tube, and the filaments wound around the cylindrical end feature of each of the end fittings at an arc of greater than 180 degrees.

2. The filament wound composite tie rod of claim 1, wherein each of the end fittings are attached to corresponding first and second ends of the structural member tube with an adhesive.

3. The filament wound composite tie rod of claim 1, wherein each of the end fittings interface to corresponding first and second ends of the structural member tube at a first taper angle of greater than zero degrees with respect to the longitudinal axis of the structural member tube.

4. The filament wound composite tie rod of claim 1, wherein each of the lugs are offset from adjacent lugs at a second angle with respect to the longitudinal axis of the structural member tube.

5. The filament wound composite tie rod of claim 3, wherein the angle and second angle are the same angle.

6. The filament wound composite tie rod of claim 1, wherein the structural member tube is hollow and the first end of the structural member tube and the second, distal end of the structural member form a tapered cross-section, an inside surface of the structural member tube tapering to a narrower width at the ends of the structural member; the cylindrical body of the end fittings also tapering symmetrical to the ends of the structural member.

7. The filament wound composite tie rod of claim 1, wherein the cylindrical end feature of the end fittings further comprise threaded features for linking to structural members.

8. The filament wound composite tie rod of claim 1, wherein the threaded features for linking to the structural members are internal to the cylindrical end feature of the end fittings.

9. A method of fabrication a filament wound composite tie rod, the method comprising:
providing a composite tie rod, comprising:
a structural member tube;
a pair of end fittings, each end fitting having a cylindrical end feature and a cylindrical body, the cylindrical body having a plurality of lugs, a first of the end fittings attached to a first end of the structural member tube and a second of the end fittings attached to a second, distal end of the structural member tube; and
winding a filament encapsulated in an uncured solid matrix a number of turns around the end fittings and longitudinally around the structural member tube, each winding of the filament being wound at an angle between 0 degrees and 90 degrees with respect to a longitudinal axis of the structural member tube, each winding passing around the cylindrical end feature of each of the end fittings at an arc of greater than 180 degrees.

10. The method of claim 9, wherein the step of winding further comprises winding of the filament between the lugs.

11. The method of claim 9, wherein an angle between adjacent lugs matches the angle between the filaments with respect to a longitudinal axis of the structural member tube.

12. The method of claim 9, further comprising performing the step of winding for half the length of the filament in a first direction and performing the step of winding for a second half the length of the filament in a direction opposite of the first direction.

13. The method of claim 9, wherein the uncured solid matrix encapsulating said wound filament is cured to form a solid matrix.

14. A filament wound composite tie rod comprising:
a structural member tube;
a pair of end fittings, each end fitting having a cylindrical end feature and a cylindrical body, the cylindrical body having a plurality of lugs, a first of the end fittings attached to a first end of the structural member tube and a second of the end fittings attached to a second, distal end of the structural member tube;
at least one filament held in a cured solid matrix wound repeatedly around the end fittings and wound longitudinally along the structural member tube, each of the at least one filaments being wound at an angle between 0 degrees and 90 degrees with respect to a longitudinal axis of the structural member tube, and each of the at least one filaments wound around the cylindrical end feature of each of the end fittings at an arc of greater than 180 degrees.

15. The filament wound composite tie rod of claim 14, wherein each of the end fittings are attached to corresponding first and second ends of the structural member tube with an adhesive.

16. The filament wound composite tie rod of claim 14, wherein each of the end fittings interface to corresponding first and second ends of the structural member tube at a first taper angle of greater than zero degrees with respect to the longitudinal axis of the structural member tube.

17. The filament wound composite tie rod of claim 14, wherein each of the lugs are offset from adjacent lugs at a second angle with respect to the longitudinal axis of the structural member tube.

18. The filament wound composite tie rod of claim 17, wherein the angle and second angle are the same angle.

19. The filament wound composite tie rod of claim 14, wherein the structural member tube is hollow and the first end of the structural member tube and the second, distal end of the structural member form a tapered cross-section, an inside surface of the structural member tube tapering to a narrower width at the ends of the structural member; the cylindrical body of the end fittings also tapering symmetrical to the ends of the structural member.

20. The filament wound composite tie rod of claim 14, wherein the cylindrical end feature of the end fittings further comprise threaded features for linking to structural members.

21. The filament wound composite tie rod of claim 14, wherein the at least one filaments are made of a material selected from the group consisting of carbon, graphite, fiberglass, para-aramid fibers, poly paraphenylene terephthalamide fibers, aluminum, and steel.

22. The filament wound composite tie rod of claim 14, wherein filaments are rigidly held in place through the proper cure of said solid matrix.
